(19) United States
(12) Patent Application Publication
(10) Pub. No.: US 2016/0231949 A1
(43) Pub. Date: Aug. 11, 2016

(54) MEMORY CONTROLLER AND ASSOCIATED CONTROL METHOD

(71) Applicant: Realtek Semiconductor Corp., HsinChu (TW)

(72) Inventor: Ya-Min Chang, Kaohsiung City (TW)

(21) Appl. No.: 14/977,661

(22) Filed: Dec. 22, 2015

(30) Foreign Application Priority Data
Feb. 6, 2015 (TW) 104104110

(51) Int. Cl. G06F 3/06

(52) U.S. Cl. CPC G06F 3/0611; G06F 3/0659; G06F 3/0673

(57) ABSTRACT

A memory controller includes an address decoder and a protocol controller, where the address decoder is arranged for decoding a received signal to generate a plurality of command signals, where the plurality of signals are for accessing a plurality of banks of the memory and the protocol controller is arranged for re-scheduling an executing order of the plurality of command signals according to opening banks and pages, and for accessing the memory according to the plurality of command signals.

### BACKGROUND OF THE INVENTION

1. Field of the Invention

The present invention relates to a memory, and more particularly, to a Dynamic Random-Access Memory (DRAM) controller and an associated control method.

2. Description of the Prior Art

In Synchronous Dynamic Random-Access Memory (SDRAM), a read/write data procedure comprises the following actions: (1) if the non-active page of the corresponding bank is not set, an active command needs to be sent for opening the specific non-active page of the corresponding accessed bank; (2) if the active page of the corresponding bank is set, a read/write operation can be executed directly when there is a page hit; in the case of a page miss, a precharge command needs to be sent to close the current corresponding page, and then an active command must be sent to set the page which is going to be read/written, and a read/write command must be sent for performing data read/write; and (3) an auto-refresh/refresh command needs to be executed after a certain amount of time for maintaining the content data of the SDRAM.

In the control operating procedure described above, the page status of the corresponding bank needs to be checked for each access, which comprises determining a non-active page, active page, page hit or page miss, and performing a corresponding operation according to the current status for correctly performing a read or write operation to the SDRAM. Because the operating procedure is a fixed and regular decision, a Finite State Machine (FSM) method is used to control the SDRAM. The efficiency of the FMS method is usually limited, however, so the frequency of an executing command cannot be elevated, which delays the executing period. This may degrade the read/write operation performance of the memory.

To elevate the performance of an SDRAM, using an optimization discriminant procedure flow and changing the hardware design to a pipeline can optimize the SDRAM command operation, which further achieves an effective increase in the frequency of the memory. The disadvantage is that the control is complex, which increases design difficulty, and the design cost of hardware is thus increased.

### SUMMARY OF THE INVENTION

One of the objectives of the present invention is therefore to provide a controller of an SDRAM, and an associated method, which can simplify the control design of a memory and optimize the operating performance therein to solve the problems in the prior art.

According to an embodiment of the present invention, a memory controller comprises an address decoder and a protocol control, wherein the address decoder is arranged to perform decoding on a receiving signal to generate a plurality of command signals, wherein the plurality of command signals comprise command signals accessing a plurality of banks of a memory; and the protocol controller is arranged to reschedule the executing sequence of the plurality command signals according to the opening bank and page in the memory to access the memory via the plurality of command signals.

According to another embodiment of the present invention, a memory control method comprises: performing decoding on a receiving signal to generate a plurality of command signals, wherein the plurality of command signals comprise the command signals accessing a plurality of banks of a memory; and rescheduling the executing sequence of the plurality of command signals according to the opening banks and page in the memory to access the memory via the plurality of command signals.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a memory controller according to an embodiment of the present invention.

FIG. 2 is a flowchart illustrating a memory controller accessing a memory according to an embodiment of the present invention.

FIG. 3 is a diagram illustrating a hardware architecture according to an embodiment of the present invention.

FIG. 4 is a diagram illustrating an accessing command format.

FIG. 5 is a timing diagram illustrating a page accessing different banks according to the prior art.

FIG. 6 is a timing diagram illustrating a page accessing different banks according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should not be interpreted as a close-ended term such as “consist of”. Also, the term “couple” is intended to mean either an indirect or direct electrical connection. Accordingly, if one device is coupled to another device, that connection may be through a direct electrical connection, or through an indirect electrical connection via other devices and connections.

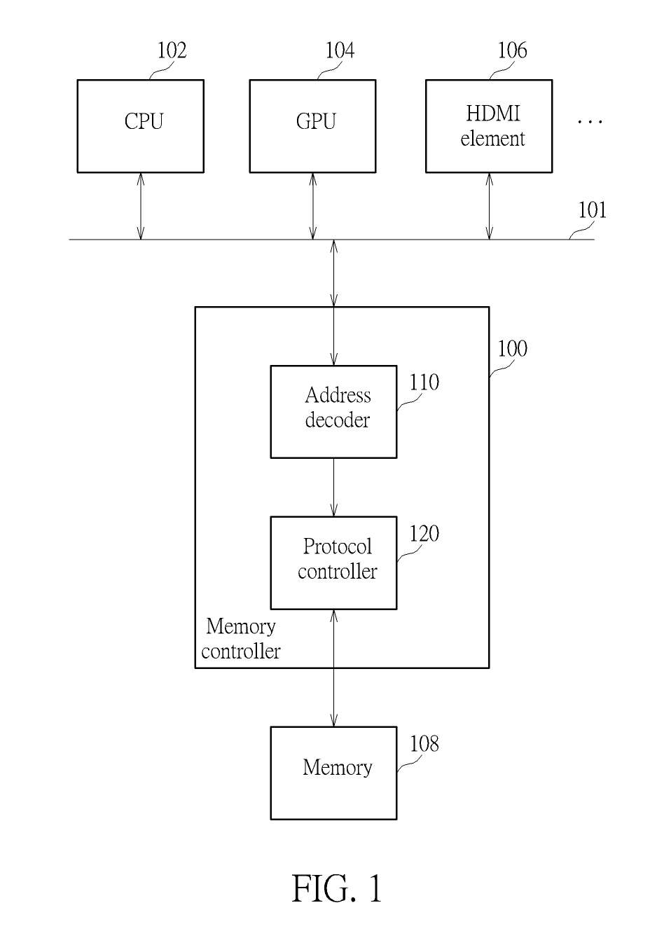

FIG. 1 is a diagram illustrating a memory controller 100 according to an embodiment of the present invention. As shown in FIG. 1, the memory controller 100 is coupled to the memory 108, and connected to elements needed to access memory 108 such as the central processing unit 102, the graphics processing unit 104, and the High Definition Multimedia Interface (HDMI) element 106 via the bus 101. The main function of the memory controller 100 is to control reading the data content of the memory 108 and writing data into the memory 108, and to perform auto refresh for maintaining the data content of the memory 108. For brevity, FIG. 1 only depicts the address decoder 110 and the protocol controller 120, but one skilled in the art should understand the memory controller 100 also comprises other necessary circuit elements.

In this embodiment, the memory controller 100 is an SDRAM controller, and the memory 108 is an SDRAM. In various SDRAM specifications, e.g. JESD79F, JESD79-2C, JESD79-3D, read/write operations to the memory 108 which to be obeyed are all stipulated. For example: (1) for the page/row address of the read/write bank, if the active command is performed on a closed bank, the corresponding waiting time of the next command is as follows: (1.1) if the next command is an active command and for a different bank, the waiting time is tRRD; (1.2) if the next command is an active command and for the same bank, the waiting time is tRC; (1.3) if the next command is a precharge command, the waiting time is tRAS. (2) if the corresponding bank has opened the page, it needs to be confirmed if the page is the same; if not, then a precharge command needs to be executed to close the current page so the wanted page can be opened, and if the precharge command is executed, the next command needs to wait for the time tRP. (3) After opening the page of the corresponding page, the read/write command can be executed, and the next read/write command needs to wait for the time tCCD. More specifically, if a reading command is being executed then, when the next command is a writing command, the waiting time is tRTW, and when the next command is a precharge command, the waiting time is tRTP; if a writing command is being executed then, when the next command is a reading command, the waiting time is tWTR, and when the next command is a precharge command, the waiting time is tWR. (4) because the memory 108 needs to charge every row address for every tREFI in order to maintain the correctness of the content of the memory 108, the auto-refresh/refresh needs to be executed in this time, and the next command needs to wait for the time tRFC; and before executing the auto-refresh/refresh command, a precharge all/precharge command needs to be executed first.

According to the above mentioned operating commands, when executing different commands, a next command has a different time limit (waiting time), and in these different time limits, there is no connection between some commands. In addition, there is a plurality of banks in the memory 108, wherein each bank may have a different page address (row address). During every read/write of data, it needs to be confirmed if the page of the corresponding bank is opened.

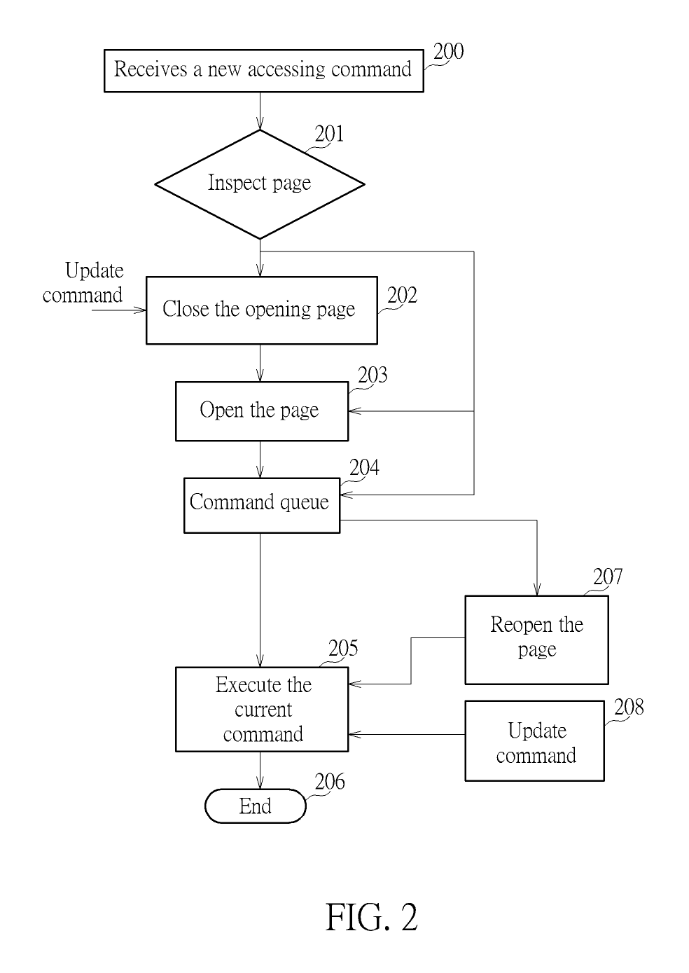

Therefore, the present invention provides a method for accessing the memory 108 according to a command and the memory control characteristics so that the architecture can be a pipeline to process a plurality of command operations in parallel. FIG. 2 is a flowchart illustrating a memory controller 100 accessing a memory 108 according to an embodiment of the present invention, wherein the flow is described as follows.

In step 200, the memory controller 100 receives a new accessing command for a read/write of at least a page of a bank of the memory 108. In step 201, the memory controller 100 inspects the status of the page, wherein if the page of the bank is not opened, the flow moves to step 203 to open the page; if the page of the bank is opened, the flow moves to step 204 to wait for the command to be executed in the command queue; if another page is opened in the bank and there is no command waiting or being executed, the flow enters step 202 to close the current page; and, if another page of the bank is opened and there is a command waiting or being executed, the flow enters step 204 for waiting in the command queue.

In step 202, after confirming the time limit is not met, the precharge command is executed for closing the opening page of the bank. The flow enters step 203.

In step 203, after confirming the time limit is not met, the active command is executed for opening the page. The flow then enters step 204.

In step 204, the command which enters the command queue follows the first in first out rule. When the next command waits at the output terminal to entering step 205 for executing the operation, it is determined if the page needs to be reopened. If the pages accessed by the next command and the executing command are located in different banks, the flow enters step 207 to reopen the page, i.e. executing the precharge operation and the active command. When the current command finishes executing, the flow enters step 205; and if the pages accessed by the next command and the current executing command are located in the same bank, the flow waits until the current command finishes then enters step 207 to reopen the page, i.e. executing the precharge operation and the activate command. The flow then enters step 205.

In step 205, the current command is executed and if there is a command waiting to be executed in the command sequence of step 204, the waiting command will be executed. Step 206 is then entered to end the flow.

The memory 108 needs to maintain the correctness of the data, therefore, step 202 is triggered to close all banks or corresponding banks then the update command is executed in step 208.

According to the operating flow shown in FIG. 2, a pipeline may be applied to the hardware architecture. A further advantage is that the method can coordinate with associated hardware information so it is checked in each step whether memory command control can be emitted, and after an optimize order, the command which needs to be executed is selected.

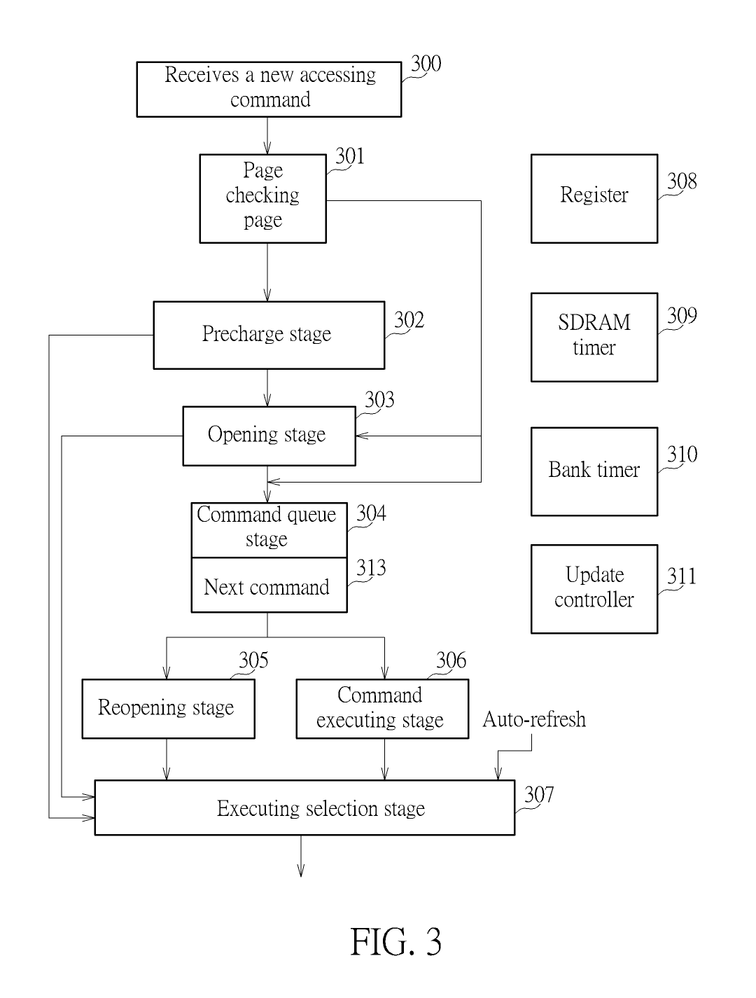

FIG. 3 is a diagram illustrating a hardware architecture according to an embodiment of the present invention, wherein the steps 302 to 307 shown in FIG. 3 are implemented by the protocol controller 120 of the memory controller 100. The element 308 may be a register which is arranged to store the opening bank and page. The SDRAM timer is arranged to determine when to trigger the auto-refresh/refresh command, the bank timer 310 is arranged to determine when to launch the precharge command, and the update controller 311 is arranged to determine, according to a timekeeping result of the SDRAM timer 309, when to trigger the auto-refresh/refresh command. The elements 308, 309, 310, 311 are positioned within the memory controller 100.

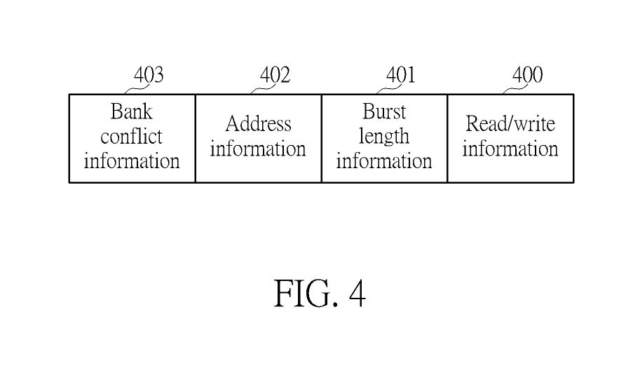

In step 300, a new accessing command is received, wherein the format of the accessing command may comprise read/write information 400, burst length information 401, address information 402 and bank conflict information 403 as shown in FIG. 4.

In the page checking stage 301, the opening bank and page recorded in the element 308 and the address information 402 in the accessing command need to be checked to determine whether the corresponding page (row address) conflicts. The flow then goes to the precharge stage 302, opening stage 303 or the command queue 304 according to different statuses, and records whether to reopen the page (row address) into the bank conflict information 403 of the accessing command.

In the precharge stage 302, the opening stage 303 and the command queue 304, the SDRAM timer 309 and the bank timer 310 need to be checked to determine whether to execute the step command to avoid violating the command time limit of the SDRAM.

For the command queue stage 304, in a hardware design, a register with a FIFO-like architecture is used to store command information. Due to the limit storing space in the command queue stage 304, when the register has storing space, it is capable of receiving the commands sent by the previous step; if the number of commands waiting to be executed in the register reaches the maximum storing number, then the commands from the previous steps need to wait to be received.

In the command queue stage 304, the command at the output is defined to be the next command 313; if the next command 313 needs to reopen the page(row address), it checks with the command in the command executing stage 306 to see whether they are the same bank. If not, the flow goes to the reopening stage 305 to execute the operation of reopening a page in advance; when the page has finished opening, the next command 313 is sent from the command queue stage 304 and goes to the command executing stage 306. In contrast, if the page which needs to be reopened in the next command 313 is in the same bank as the page accessed by the command in the command executing stage 306, then the flow waits until the executing command in the command executing stage 306 is finished then performs a reopening operation to avoid affecting the command reading/writing address in the command executing stage.

In the command queue stage 304, it is determined whether to open the page, wherein once the auto-refresh/refresh command is executed, the precharge all/precharge command is executed first which may close all of the banks or some specific banks. If the page was closed before, the flow requests to open again in the command queue stage 304 then executes the read/write command one or more times consecutively according to the element 308 and the bank conflict information 403. When the command is finished executing, the next command 313 is checked to see whether launching an inflow request is favorable for executing a read/write consecutively in a next time.

When executing selection stage 307, the order of executing priority is performed according to the precharge stage 302, the opening stage 303, the reopening stage 305, and the command executing stage 306 so that the memory controller 100 can process a plurality of read/write requests, and determine, according to different banks, whether to execute the operation corresponding to the row address setting in advance to reduce the waiting time when a read/write command operation needs to be executed. The priority order of executing substantially follows the auto-refresh/refresh command, the command executing stage 306, the reopening stage 305, the opening stage 303 and the precharge stage 302 in sequence.

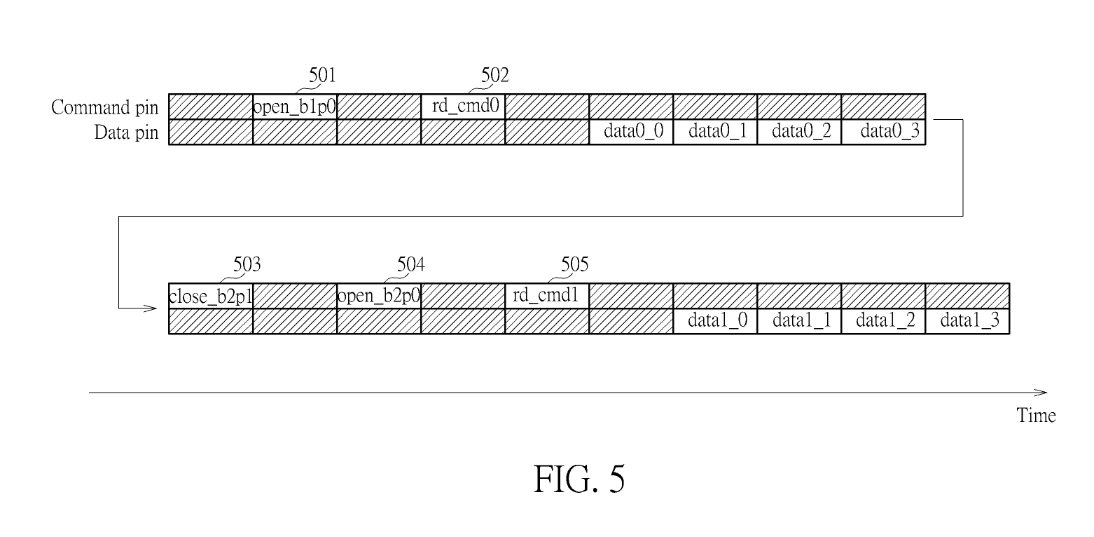

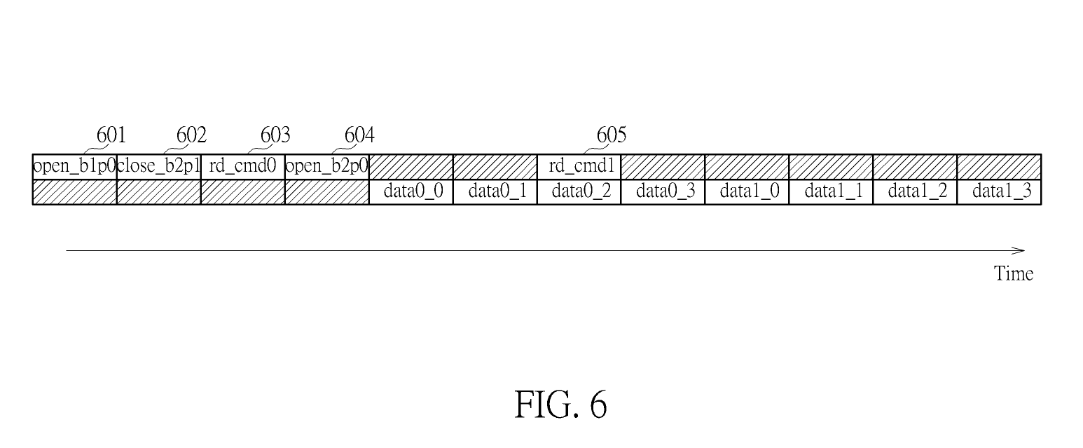

For an example of how the architecture shown in FIG. 3 can improve the performance of the memory controller 100 when accessing the memory 108, refer to FIGS. 5 and 6. FIG. 5 is a timing diagram illustrating the page accessing different banks in the prior art and FIG. 6 is a timing diagram illustrating the page accessing different banks according to an embodiment of the present invention.

Referring to the timing diagram shown in FIG. 5, assume the memory controller 100 needs to read the data of the 0^{th} page in the first bank first then the data of the 0^{th} page in the second bank, and the 1^{st} page in the second bank is opening. In the prior art, the memory controller 100 transmits the opening command 501 (open_b1p0) via the command pins to the memory 108 for opening the 0^{th} page in the first bank, then transmits the read command 502 (rd_cmd0) to the memory 108 for reading data data0_0, data0_1, data0_2, data0_3 from the memory 108 via the data pins. Next, the memory controller 100 transmits the closing command 503 (close_b2p1) to the memory 108 for closing the 1^{st} page in the second bank. Next, the memory controller 100 transmits the opening command 504 (open_b2p0) to the memory 108 for opening the 0^{th} page in the second bank, then transmits the read command 505 (rd_cmd1) to the memory 108 for reading data data1_0, data1_1, data1_2, data1_3 from the memory 108. In the operation shown in FIG. 5, because it is necessary to wait between every command, and there is also a necessary waiting time between the read command and starting to read data, reading data has a poorer performance.

Referring to the timing diagram shown in FIG. 6, assume the memory controller 100 needs to read the data of the 0^{th} page in the first bank first then the data of the 0^{th} page in the second bank, and the 1^{st} page in the second bank is opening. In this embodiment of the present invention, the memory controller 100 transmits the opening command 601 (open_b1p0) via the command pins to the memory 108 for opening the 0^{th} page in the first bank. Next, because the waiting time between the opening command 601 and the closing command 602 for closing the 1^{st} page in the second bank is not very long, after opening the command 601, the memory controller 100 can transmit the closing command 602 (close_b2p1) immediately to the memory 106 for closing the 1^{st} page in the second bank. Next, the memory controller 100 transmits the read command 603 (rd_cmd0) to the memory 108 to ask for reading the data in the memory 108. Then, because the waiting time between the read command 603 and the opening command 604 of the 0^{th} page in the second bank is not very long, after the read command 603, the memory controller 100 can transmit the opening command 604 (open_b2p0) immediately to the memory 108 for opening the 0^{th} page in the second bank. Next, the memory 108 starts to correspond to the read command 603 to transmit the data data0_0, data0_1, data0_2, data0_3 back via the data pins, and during the process of transmitting back the data data0_0, data0_1, data0_2, data0_3, the memory controller 100 can send the read command 605 (rd_cmd1) to the SDRAM108 to ask to read the data in the 0^{th} page in the second bank of the memory 108. Therefore, after transmitting the data data0_0, data0_1, data0_2, data0_3, the memory 108 can correspond to the read command 605 immediately to send data data1_0, data1_1, data1_2, data1_3 back via the data pins.

Compared to the prior art method of FIG. 5, in the flow of FIG. 6, because the steps of closing the 1^{st} page in the second bank and opening the 0^{th} page in the second bank are moved forward for executing, after the memory 108 corresponds to the read command 603 to transmit the data data0_0, data0_1, data0_2, data0_3 back, the memory 108 can correspond to the read command 605 immediately to transmit the data data1_0, data1_1, data1_2, data1_3 back so that the memory controller 100 can constantly receive the needed data via the data pins to increase the accessing efficiency of the memory controller 100. It should be noted that the commands 601 and 603 are not limited to be the examples illustrated in the embodiment of FIG. 6. In other embodiments, the commands 601 and 603 can be any normal DRAM command. For example, active command, precharge command, write command or read command, etc. These alternative designs shall be fall within the scope of the present invention.

Briefly summarized, the memory controller and the associated control method optimize the operating performance of the memory via an order rearrange with respect to accessing command by the protocol controller. More particularly, the memory controller and control method can open the following pages waiting to be accessed in advance to make the data transmission between the memory controller and the memory as consecutive as possible for increasing the usage rate of the memory bandwidth.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A memory controller, comprising:
an address decoder, arranged for performing a decoding operation on a received signal to generate a plurality of command signals, wherein the plurality of command signals comprise command signals arranged for accessing a plurality of banks in a memory; and
a protocol controller, coupled to the address decoder, where the protocol controller is arranged to re-determine an executing order of the plurality of signals according to an address of the bank, and a page in the memory needs to be accessed by the plurality of command signals.

2. The memory controller of claim 1, wherein the protocol controller performs an examination of the plurality of commands sequentially to determine whether a bank conflict occurs, and makes the plurality of command signals move into a precharge stage, an opening stage or a command queue stage according to a determination result, wherein the precharge stage is for closing the pages in a corresponding bank, the opening stage is for opening the pages in the corresponding bank, and the command queue stage is for sequentially storing the entered commands; and according to the opening bank and page in the memory, the protocol controller determines whether the commands sequentially outputted by the command queue stage enter into a reopening stage or a command executing stage, wherein the reopening stage is for reopening the page in the corresponding bank; and the protocol controller determines which stage operation needs to be executed first according to the command signals corresponding to the closing stage, the open stage, the reopening stage and the command executing stage.

3. The memory controller of claim 2, wherein the protocol controller determines which stage operation needs to be executed first according to banks which need to be accessed by the command signals corresponding to the precharge stage, the opening stage, the reopening stage and the command executing stage.

4. The memory controller of claim 3, wherein the protocol controller preferentially executes the banks which need to be accessed in the precharge stage, the opening stage, the reopening stage and the command executing stage which differ from the current bank open in the memory.

5. The memory controller of claim 1, wherein the plurality of command signals sequentially comprise the command signals arranged for accessing a page of a first bank and a page of a second bank of the memory, and before the memory controller accesses a data of the page of the first bank, the protocol controller transmits a command to the memory for opening the page of the second bank, and asks to access the page of the second bank.

6. The memory controller of claim 5, wherein when there are other pages of the second bank opening, the protocol controller sequentially transmits a first opening command to the memory for opening the page of the first bank, a closing command to the memory for closing the other opening pages of the second bank, a first read command to the memory to ask to access the page of the first bank, a second opening command to the memory for opening the page of the second bank, and a second read command to the memory to ask to access the page of the second bank.

7. The memory controller of claim 5, wherein when there are other pages of the second bank opening, the protocol controller sequentially transmits a first normal DRAM command of the first bank, a closing command to the memory for closing the other opening pages of the second bank, a second normal DRAM command to the memory to ask to access the page of the first bank, an opening command to the memory for opening the page of the second bank, and a read command to the memory to ask to access the page of the second bank.

8. A memory control method, comprising:
decoding a received signal to generate a plurality of signal commands, wherein the plurality of signal commands comprise command signals arranged for accessing a plurality of banks in a memory;
re-determining the executing order of the plurality of command signal according to the opening bank and a page of the memory to utilize the plurality of command signals for accessing the memory.

9. The memory control method of claim 8, wherein the step of re-determining the executing order of the plurality of command signals according to the opening bank and page of the memory comprises:
performing an examination on the plurality of commands sequentially to determine whether a bank conflict occurs, and making the plurality of command signals move into a precharge stage, an opening stage or a command queue stage according to a determination result, wherein the precharge stage is for closing the pages in a corresponding bank, the opening stage is for opening the pages in the corresponding bank, and the command queue stage is for sequentially storing the entered commands;
according to the opening bank and page in the memory, determiing whether the commands sequentially outputted by the command queue stage enter into a reopening stage or a command executing stage, wherein the reopening stage is for reopening the page in the corresponding bank; and
determining which stage operation needs to be executed first according to the command signals corresponding to the closing stage, the open stage, the reopening stage and the command executing stage.

10. The memory control method of claim 9, wherein the step of determining which stage operation needs to be executed according to the command signals corresponding to the precharge stage, the opening stage, the reopening stage and the command executing further comprises:
determining which stage operation needs to be executed first according to banks which need to be accessed by the command signals corresponding to the precharge stage, the opening stage, the reopening stage and the command executing stage.

11. The memory control method of claim 10, wherein the step of determining which stage operation needs to be executed according to the command signals corresponding to the precharge stage, the opening stage, the reopening stage and the command executing further comprises:
preferentially executing the banks which need to be accessed in the precharge stage, the opening stage, the reopening stage and the command executing stage which differ from the current bank opening in the memory.

12. The memory control method of claim 8, wherein the plurality of command signals sequentially comprise the command signals arranged for accessing a page of a first bank and a page of a second bank of the memory, the method is applied to a memory controller, and the method further comprises:
before the memory controller accesses a data of the page of the first bank, the memory controller transmits a command to the memory for opening the page of the second bank, and asks to access the page of the second bank.

13. The memory control method of claim 12, wherein the step of the memory controller transmitting a command to the memory for opening the page of the second bank, and asking to access the page of the second bank before the memory controller accesses a data of the page of the first bank comprises:
when there are other pages of the second bank opening, sequentially transmitting a first opening command to the memory for opening the page of the first bank, a closing command to the memory for closing the other opening pages of the second bank, a first read command to the memory to ask to access the page of the first bank, a second opening command to the memory for opening the page of the second bank, and a second read command to the memory to ask to access the page of the second bank.

14. The memory control method of claim 12, wherein when there are other pages of the second bank opening, sequentially transmitting a first normal DRAM command of the first bank, a closing command to the memory for closing the other opening pages of the second bank, a second normal DRAM command to the memory to ask to access the page of the first bank, an opening command to the memory for opening the page of the second bank, and a read command to the memory to ask to access the page of the second bank.
